(19) United States
(12) Patent Application Publication
(10) Pub. No.: US 2013/0304938 A1
(43) Pub. Date: Nov. 14, 2013

(54) MINIMIZING INTERFERENCE IN LOW LATENCY AND HIGH BANDWIDTH COMMUNICATIONS

(71) Applicant: QUALCOMM INCORPORATED, San Diego, CA (US)

(72) Inventors: Kevin Neal Hayes, Mountain View, CA (US); Prerepa Viswanadham, Fremont, CA (US)

(73) Assignee: QUALCOMM INCORPORATED, San Diego, CA (US)

(21) Appl. No.: 13/799,285

(22) Filed: Mar. 13, 2013

Related U.S. Application Data
(60) Provisional application No. 61/645,978, filed on May 11, 2012.

(51) Int. Cl. H04L 12/56

(52) U.S. Cl. CPC H04L 45/22
USPC 709/239

(57) ABSTRACT

A central coordinator can execute operations to minimize in-network contention and external network interference in a communication network. The central coordinator can determine to switch to alternate communication channel if performance of the alternate communication channel surpasses the performance of a current communication channel. A multicast channel switch message is transmitted to a plurality of client devices associated with the central coordinator. If an acknowledgement for the multicast channel switch message is not received from a first client device, the central coordinator causes remainder of the plurality of client devices to defer switching to the alternate communication channel and transmits a unicast channel switch message to the first client device. The central coordinator and the associated client devices switch to alternate communication channel after an acknowledgement is received from all the client devices.

### RELATED MATTERS

This application claims the priority benefit of U.S. Provisional Application No. 61/645,978 filed on May 11, 2012.

### BACKGROUND

Embodiments of the inventive subject matter generally relate to the field of communication networks and, more particularly, to minimizing interference in low latency and high bandwidth communications.

Wireless communication systems in a wireless communication network can use one or more channels to transfer data between a transmitter and receivers. Data to be transferred can have different quality of service (QoS) requirements. For example, the wireless communication systems may transfer data with varying bandwidth, latency, and other resource/performance requirements. The data transfer between the wireless communication systems can be impacted by in-network interference and also external network interference.

### SUMMARY

Various embodiments for minimizing interference in a communication network are disclosed. In one embodiment, a central coordinator of a communication network determines to switch from a current communication channel to an alternate communication channel. A first channel switch message is transmitted to a plurality of client devices associated with the central coordinator. It is determined whether an acknowledgement for the first channel switch message is received from each of the plurality of client devices. In response to determining that the acknowledgement for the first channel switch message is received from each of the plurality of client devices, the central coordinator switches to the alternate communication channel. In response to determining that the acknowledgement for the first channel switch message is not received from a first client device, the central coordinator transmits a second channel switch message to the first client device and determines not to switch to the alternate communication channel.

### BRIEF DESCRIPTION OF THE DRAWINGS

The present embodiments may be better understood, and numerous objects, features, and advantages made apparent to those skilled in the art by referencing the accompanying drawings.

FIG. 1 depicts an example conceptual diagram including a mechanism for minimizing interference in a communication network;

FIG. 2 is an example packet format including at least one communication superframe and constituent communication time slots;

FIG. 3 is a flow diagram illustrating example operations of a central coordinator executing a registration process;

FIG. 4 is a flow diagram illustrating example operations of a central coordinator executing communication channel switching operations;

FIG. 5 is a continuation of FIG. 4 and also illustrates example operations of a central coordinator executing communication channel switching operations;

FIG. 6 is a flow diagram illustrating example operations of a client device connecting to and communicating with a central coordinator of a communication network; and

FIG. 7 is a block diagram of one embodiment of an electronic device including a mechanism for minimizing interference in a communication network

### DESCRIPTION OF EMBODIMENT(S)

The description that follows includes exemplary systems, methods, techniques, instruction sequences, and computer program products that embody techniques of the present inventive subject matter. However, it is understood that the described embodiments may be practiced without these specific details. For instance, although examples refer to a mechanism for minimizing interference in a wireless local area network (WLAN), embodiments are not so limited. In other embodiments, communication devices that implement other suitable standards and technologies (e.g., Bluetooth® technologies) can execute the operations described herein. In other instances, well-known instruction instances, sequences, protocols, structures, and techniques have not been shown in detail in order not to obfuscate the description.

In some communication environments, multiple data streams (each with potentially different latency and delivery requirements) may have to be transmitted from multiple client devices to a central coordinator of a communication network. In one example of a gaming environment, each of the data streams can be a command data stream, an audio data stream, or a video data stream. The command data stream may have low latency requirements, while the high bandwidth audio data stream and the high bandwidth video data stream may not have strict latency requirements as compared to the command data stream. At any given time, a client device could transmit any type of data stream. Because the composition of the multiple data streams (e.g., number of each type of data stream) that can be transmitted to the central coordinator is unknown, it may be difficult to ensure delivery of the low latency data streams. Furthermore, contention between client devices in the communication network may result in low latency data not being transmitted to the central coordinator in a timely manner.

In some embodiments, the central coordinator can be configured to aggregate multiple data streams from corresponding multiple client devices in the communication network into a logical service period, referred to herein as a “communication superframe.” Each of the multiple client devices can be assigned a communication time slot within the communication superframe. The central coordinator can minimize contention among client devices in the communication network by ensuring that each client device transmits their respective uplink data packets (to the central coordinator) only during the communication time slot assigned to the client device. Likewise, the central coordinator can also transmit downlink data packets intended for each client device in the appropriate communication time slot assigned to the client device. Aggregation of data streams from multiple client devices into one communication superframe can ensure that each client device gets a fair chance to communicate with the central coordinator. Aggregation of data streams from multiple client devices into one communication superframe can also help combine uplink and downlink low-latency (e.g., control command) traffic and high bandwidth (e.g., media) traffic while supporting low latency delivery requirements. In other words, assigning a communication time slot to each client device in the communication network can ensure that delivery of low latency data without the client devices contending for the communication channel.

In addition, the central coordinator can monitor the performance of a current communication channel and one or more other communication channels. If the central coordinator determines that another communication channel (“alternate communication channel”) has a better performance than the current communication channel, the central coordinator can transmit a multicast channel switch message to all the client devices in the communication network. If even one client device does not acknowledge the multicast channel switch message, the central coordinator can cause the client devices to defer switching to the alternate communication channel and can transmit a unicast channel switch message to the non-responsive client device during the communication time slot assigned to the client device. The central coordinator can direct all the client devices to switch to the alternate communication only if it receives a response to the multicast (or unicast) channel switch messages from all the client devices. This can ensure that none of the client devices is dropped from the communication network. For example, in the gaming environment, the central controller can ensure that none of the client devices is dropped during a gaming session while attempting to switch to an alternate communication channel.

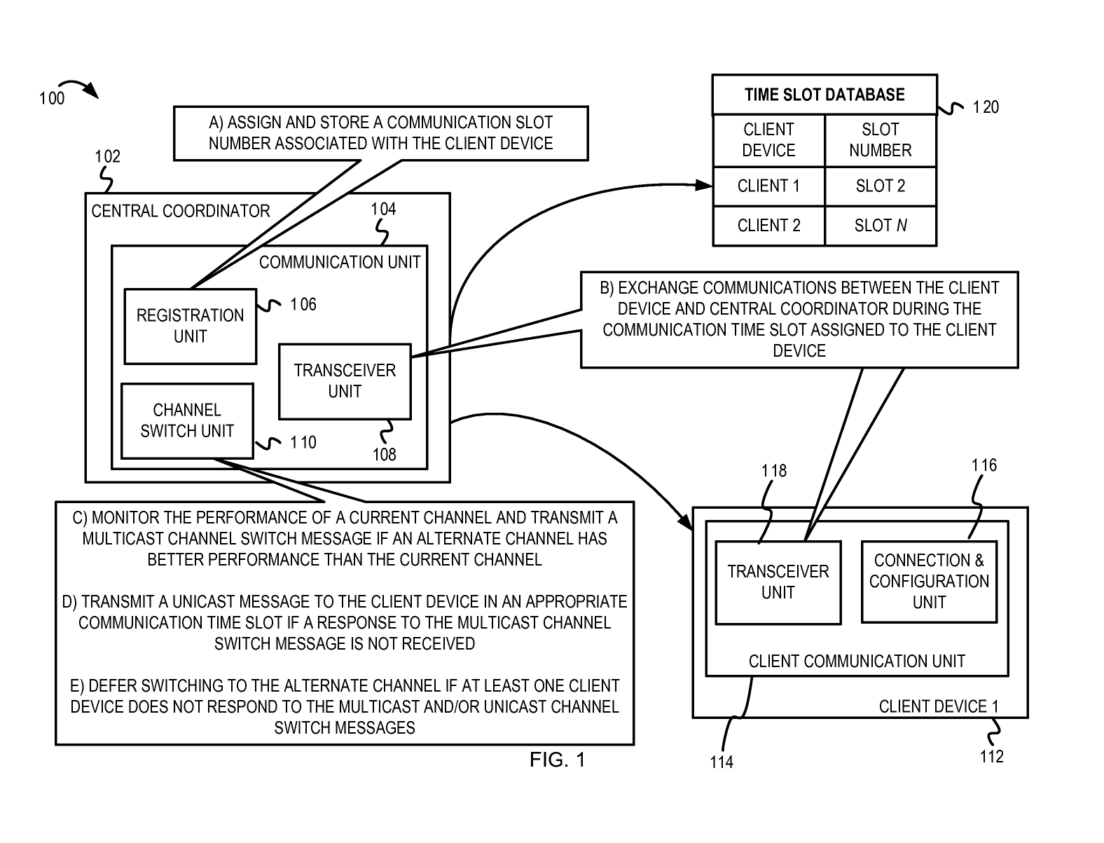

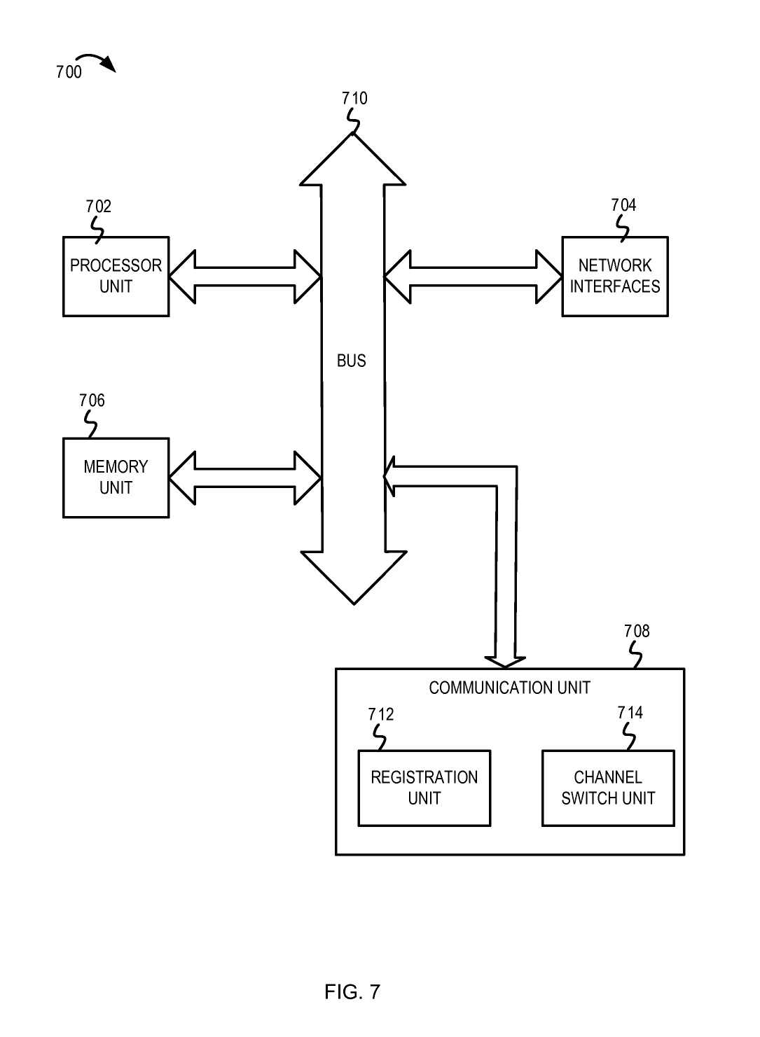

FIG. 1 depicts an example conceptual diagram including a mechanism for minimizing interference in a communication network 100. The communication network 100 comprises a central coordinator 102 and a client device 112. The central coordinator 102 comprises a communication unit 104. The communication unit 104 comprises a registration unit 106, a transceiver unit 108, and a channel switch unit 110. Additionally, the central coordinator 102 also comprises (or is coupled with) a time slot database 120. The client device 112 comprises a client communication unit 114. The client communication unit 114 comprises a connection and configuration unit 116 and a transceiver unit 108. In one embodiment, the communication network 100 may be a local video gaming network (e.g., a gaming network within a user's home). The central coordinator 102 may be part of a gaming console and the client device 112 may be a gaming controller that a user (playing the video game) can use to provide user input (e.g., by pressing buttons, speaking commands, moving the controller, etc.). In another embodiment, the central coordinator 102 may be a WLAN access point and the client device 112 may be a WLAN station. The WLAN access point and the WLAN stations in the communication network 100 may exchange different types of data with different latency requirements. It is noted that in some embodiments the client device 112 may be any suitable type of mobile device that can be used (or configured) as a gaming controller to play video games (e.g., a mobile phone or tablet computer). It should be noted that in other embodiments, the central coordinator 102 and/or the client device 112 can each be an electronic device with wired/wireless communication capabilities such as a laptop computer, a tablet computer, a mobile phone, a smart appliance, an access point, a desktop computer, a laptop computer, or other suitable electronic devices. Furthermore, the communication unit 104 and client communication unit 114 can each be implemented on a system-on-a-chip (SoC), an application specific integrated circuit (ASIC), or another suitable integrated circuit (IC) within the corresponding device. In some embodiments, the communication units may each be implemented, at least in part, using one or more processors and memory, and may each be implemented in one or more integrated circuits on one or more circuit boards of their respective network device (e.g., as described further below with reference to FIG. 7).

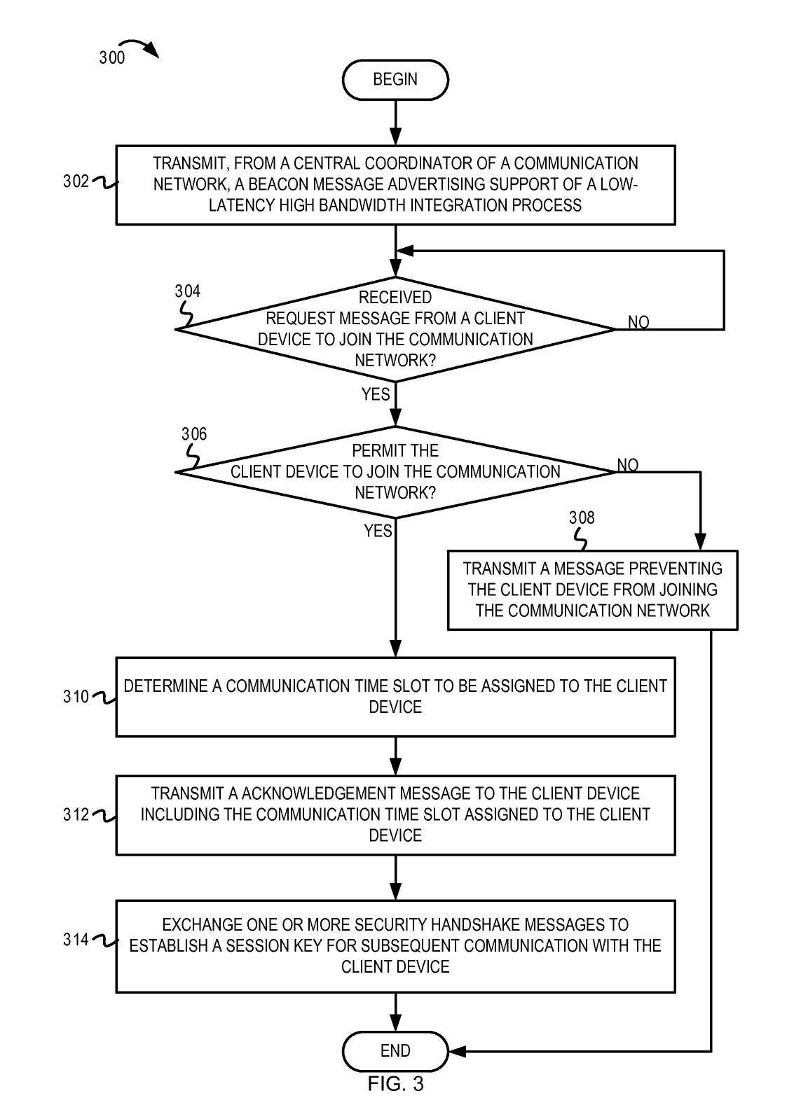

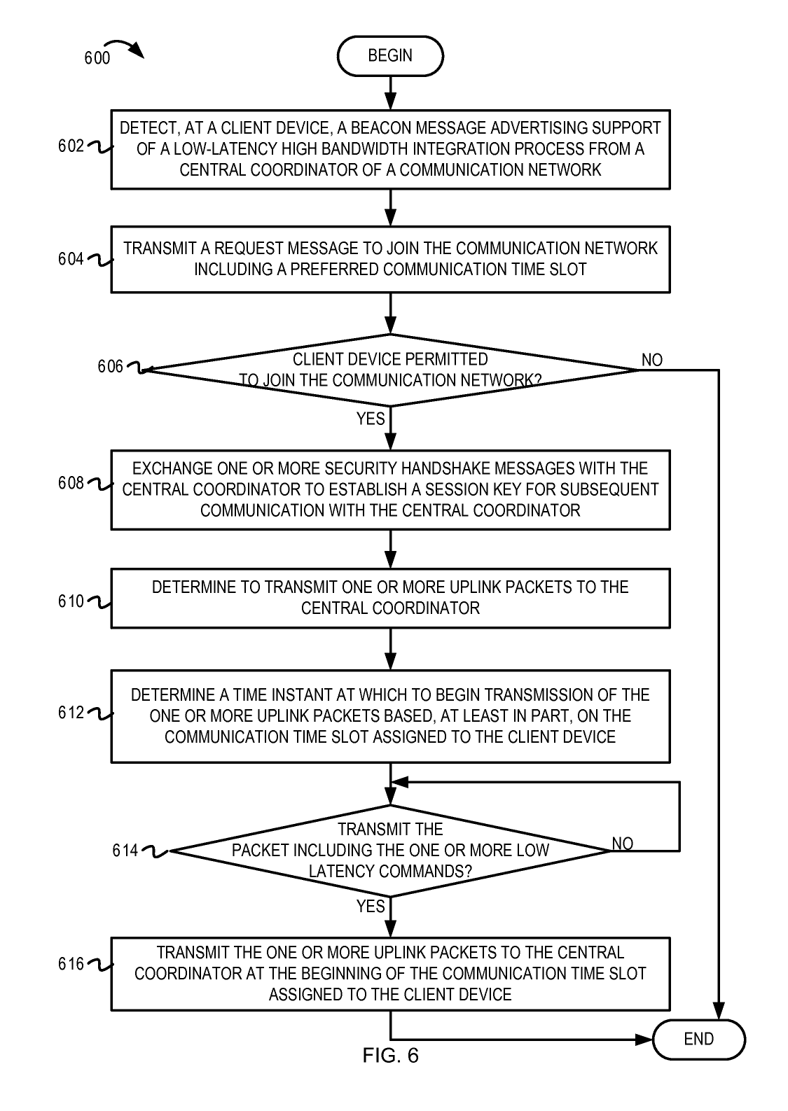

The client device 112 can attempt to join the communication network 100 (governed by the central coordinator 102) by establishing a communication link with the central coordinator 102. For example, the connection and configuration unit 116 can receive a beacon message from the registration unit 106 of the central coordinator 102 and can transmit an association request message to the central coordinator 102. The registration unit 106 can determine whether the client device 112 should be permitted to join the communication network 100 (e.g., based on analyzing and comparing communication capabilities of the central coordinator 102 and the client device 112). The registration unit 106 can transmit (e.g., via the transceiver unit 108) an association response message either granting or denying the client device 112 permission to join the communication network 100. At stage A, the registration unit 106 assigns a communication time slot (further described below) to the client device 112. The registration unit 106 may store a client device identifier and a corresponding communication time slot identifier in the time slot database 120. In other embodiments, however, an indication of the communication time slot assigned to each client device in the communication network 100 can be stored in temporary cache memory, a data structure, or other suitable internal/external storage mechanisms/devices. Operations of the central coordinator 102 and the client device 112 executing the registration process to assign a communication time slot to the client device 112 will further be described in blocks 302-314 of FIG. 3 and in blocks 602-606 of FIG. 6.

The communication network 100 typically supports two types of communication—communication from the client device 112 to the central coordinator 102 (“uplink traffic”) and communication from the central coordinator 102 to the client device 112 (“downlink traffic”). In one example of a gaming environment, the uplink traffic can include control commands and audio data. For example, the client device 112 (e.g., the gaming controller) may comprise multiple sensors (e.g., a heat sensor, a gyrometer, an accelerometer, an altimeter, etc.). Data detected by the sensors can constitute the control commands that are to be transmitted to the central coordinator 102. Moreover, events generated in response to user input (e.g., the user pushing a button, speaking a command, reacting to on-screen content, etc.) may also constitute the control commands that are to be transmitted to the central coordinator 102. The sensor data and the user input events can be aggregated into an uplink packet for transmission to the central coordinator 102. The central coordinator 102 can receive the uplink packet and can provide the uplink packet to one or more suitable processing units (e.g., a graphics processing unit) for subsequent processing. Based on analyzing the received uplink packet (i.e., the sensor data and the user input events), one or more downlink command packets, downlink audio packets, and/or downlink video packets can be generated. For example, the downlink command packets can include commands that cause the client device 112 (e.g., the gaming controller) to perform an action (e.g., vibrate, activate an LED, play a sound, etc.). As another example, the downlink video packet can indicate how the graphics presented on a screen should be varied (e.g., to reflect the previously transmitted user input). The central coordinator 102 can transmit the downlink command, audio, and/or video packets to the appropriate destination client device 112. It should be noted that in other embodiments, the uplink traffic can also comprise other suitable types of data (e.g., text, video, etc.).

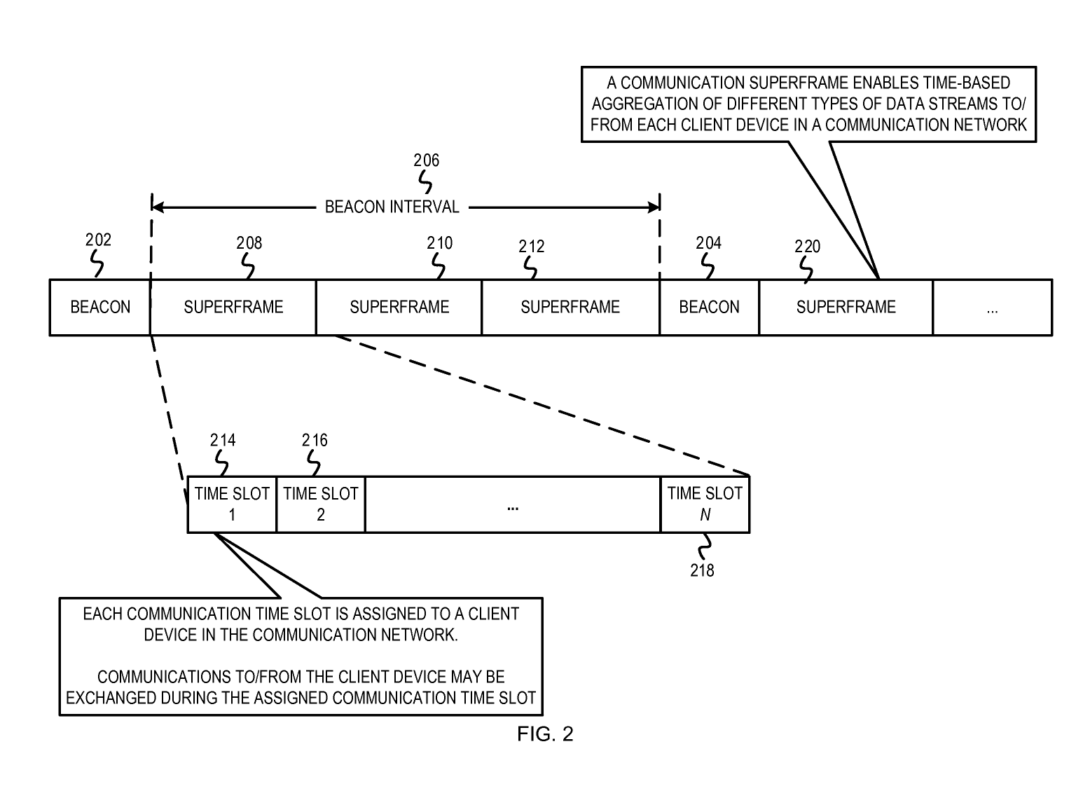

Typically, each of the different types of data streams (e.g., uplink and downlink control command traffic, bidirectional audio traffic, unidirectional video traffic, etc.) can have different latency requirements. For example, the low bandwidth command data stream may have low latency requirements (e.g., 4 ms), the high bandwidth audio data stream may have moderate latency requirements (e.g., 20 ms), while the high bandwidth video data stream may not have strict latency requirements (e.g., 32 ms) To accommodate all the different types of data streams from different client devices and to ensure that transmission of each of the types of data streams satisfies the predetermined latency and delivery requirements, the central coordinator 102 and the client devices 112 in the communication network 100 can implement a communication superframe. The communication superframe can be a periodic service period with a predetermined size (e.g., a 32 ms time interval). The communication superframe can enable time-based aggregation of different types of data streams to/from each client device 112 in the communication network 100. As depicted in FIG. 2, the central coordinator 102 typically transmits beacon messages 202 and 204 at periodic intervals. The time interval between two consecutive beacon messages 202 and 204 is referred to as a “beacon interval” 206. The central coordinator 102 can schedule one or more communication superframes during the beacon interval 206. In the example depicted in FIG. 2, the beacon interval 206 comprises three communication superframes 208, 210, and 212. It is noted that in other embodiments, the beacon interval 206 can comprise any suitable number of communication superframes (e.g., depending on the length of the communication superframe and the beacon interval). During the next beacon interval, another set of communication superframes 220 can be scheduled. Although FIG. 2 depicts the start of the first communication superframe coinciding with the start of the beacon interval 206, in other implementations, the start of the first communication superframe may be scheduled to begin a predefined amount of time after the beacon message is transmitted (e.g., a predetermined amount of time after the start of the beacon interval 206). The beacon message can comprise an indication of when (e.g., a time instant or a time offset) the first communication superframe will begin.

A time-based schedule can be implemented within the communication superframe by further sub-dividing the communication superframe 208 into multiple communication time slots. Each of the communication time slots can be assigned to corresponding ones of client devices in the communication network 100. As depicted in FIG. 2, the communication superframe 208 is divided into N time slots—beginning from time slot 1 (214) and time slot 2 (216) upto time slot N (218). In some embodiments, the number and size of communication time slots per communication superframe 208 may be predefined. In other embodiments, the central coordinator 102 may dynamically vary the number and size of communication time slots per communication superframe 208 depending on the number of client devices in the communication network 100, characteristics of data to be transmitted (e.g., types of data streams, latency of each of the data streams, etc.), and/or other criteria. In some embodiments, the central coordinator 102 may connect up to a predetermined maximum number of client devices. Implementing the communication superframe 208 (or in other words, assigning different communication time slots to each client device) can help reduce contention and interference between client devices of the communication network 100. In some embodiments, a communication time slot 216 may be represented as an offset (from the beginning of the communication superframe) that indicates when the client device 112 can begin transmitting to the central coordinator 102 (or when the central coordinator 102 can begin transmitting to the client device 112). The length of the communication time slot 216 can also include one or more retransmission periods for retransmitting failed/unacknowledged packets. In some embodiments, the communication time slot 216 can allow for retransmission of only one packet. In other embodiments, the communication time slot 216 can allow for retransmission of other suitable number of packets. Referring back to FIG. 1, at stage B, the client device 112 (e.g., the transceiver unit 108) can transmit data (e.g., uplink control command data, uplink audio data, etc.) to the central coordinator 102 during the communication time slot 216 assigned to the client device 112. Likewise, the central coordinator 102 (e.g., the transceiver unit 108) can transmit data (e.g., downlink control command data, downlink audio data, downlink video data) to the client device 112 during the communication time slot 216 assigned to the client device 112.

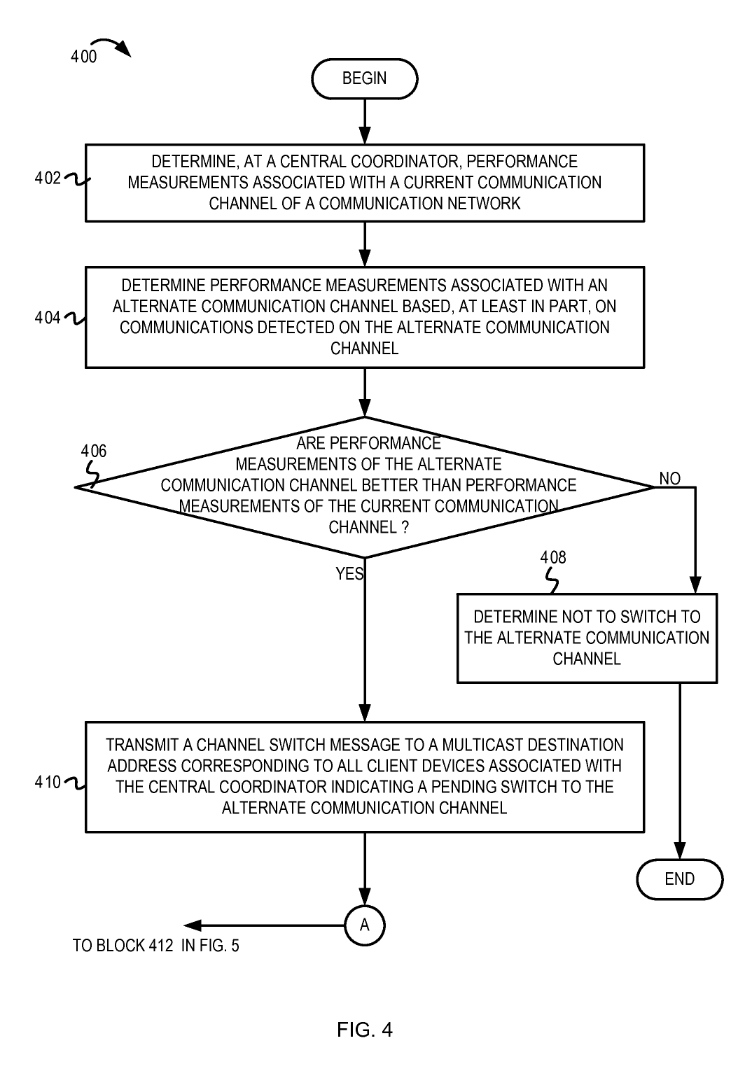

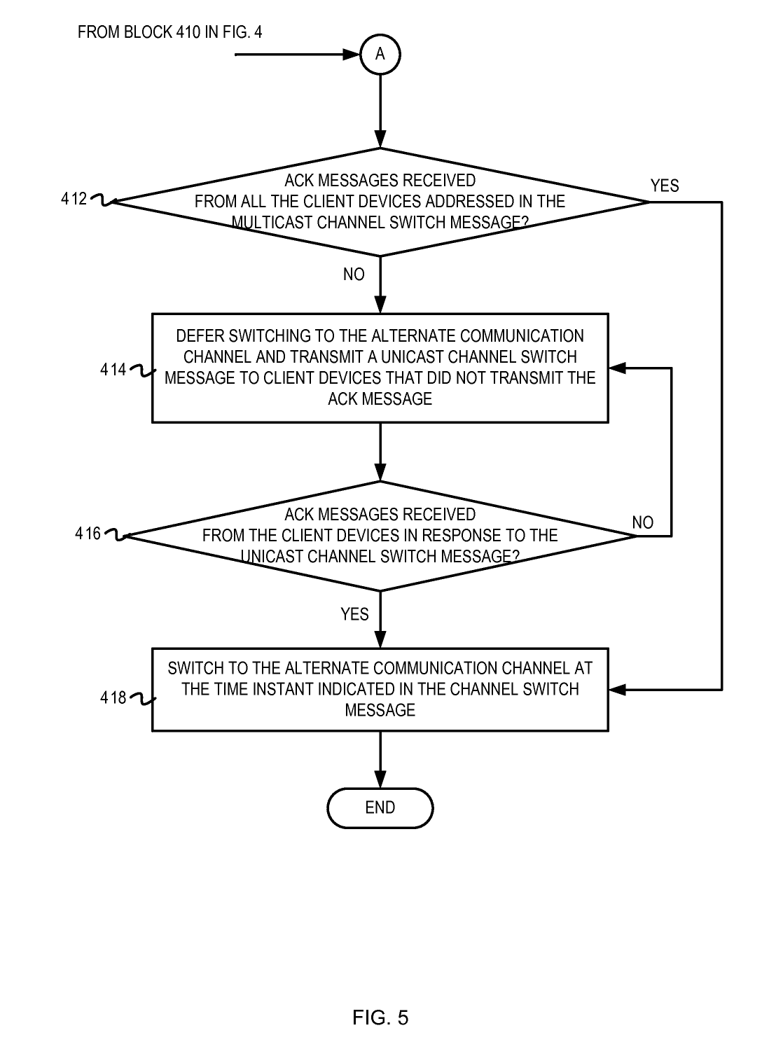

As discussed with reference to stages C-E and again with reference to FIGS. 4-5, the channel switch unit 110 can attempt to minimize interference in the communication network 100 from external networks. At stage C, the channel switch unit 110 can continuously monitor the performance of the current communication channel and one or more alternate communication channels (of the communication network). If the performance (e.g., signal-to-noise ratio (SNR)) of the alternate communication channel is better than the performance of the current communication channel, the channel switch unit 110 can determine to switch the central coordinator 102 and the associated client devices 112 to the alternate communication channel (e.g., in response to detecting data streams or other network traffic from other network devices operating on channel frequencies distinct from those of the communication network 100). For this, the central coordinator 102 (e.g., the transceiver unit 108) can transmit a multicast channel switch message to all the client devices 112 in the communication network 100. The multicast channel switch message can comprise an identifier of the alternate communication channel and an indication of when to switch to the alternate communication channel. At stage D, if the central coordinator 102 does not receive an acknowledgement message (in response to the transmitted multicast channel switch message) from one or more of the client devices (e.g., the client device 112), the central coordinator 102 can transmit a unicast channel switch message to the non-responsive client device 112 during the communication time slot 216 assigned to the non-responsive client device 112. Additionally, at stage E, the central coordinator 102 can also transmit a multicast message to the client devices in the communication network causing the client devices to defer switching to the alternate communication channel. In other words, the central coordinator 102 may not switch the client devices (and itself) to the alternate communication channel if even one of the client devices does not acknowledge the multicast channel switch message or the unicast channel switch message.

It is noted that although FIG. 1 describes execution of all the operations of stages A-E, embodiments are not so limited. In some embodiments, the central coordinator 102 and the client devices 112 may only execute operations described in stages A-B for assigning a communication time slot and for communicating during the communication time slot assigned to the client device 112. The operations described in stages C-E may not be executed. In other embodiments, the central coordinator 102 and the client devices 112 may only execute operations described in stages C-E for switching to an alternate communication channel to minimize external interference. The operations described in stages A-B may not be executed.

FIG. 3 is a flow diagram (“flow”) 300 illustrating example operations of a central coordinator executing a registration process. The flow 300 begins at block 302.

At block 302, a central coordinator of a communication network transmits a beacon message advertising support of a low-latency, high bandwidth integration process. With reference to the example of FIGS. 1 and 2, the registration unit 106 can transmit (e.g., via the transceiver unit 108) the beacon message 202 in the communication network 100. In some embodiments, the beacon message 202 can comprise communication capabilities (e.g., supported communication protocols, data rates, etc.) and current configuration of the central coordinator 102. In some embodiments, the beacon message 202 can also comprise a list of available communication time slots. As discussed above with reference to FIGS. 1-2, each client device in the communication network 100 can be associated with a communication time slot (of a communication superframe 208). Each client device may transmit their respective data/messages to the central coordinator 102 during their respective assigned communication time slot. Likewise, the central coordinator 102 can transmit data/messages for each of the client devices during the communication time slot assigned to the client device. The central coordinator 102 can keep track of (e.g., in the time slot database 120) which communication time slots have been assigned to client devices in the communication network and which communication time slots are available (e.g., have not been assigned). In the beacon message 202, the registration unit 106 can indicate the number of client devices in the communication network 100 and the number of available communication time slots. In one example, the communication superframe may comprise 18 communication time slots. The registration unit 106 may indicate, in the beacon message 202, that there are currently two client devices in the communication network 100 and 16 available communication time slots (e.g., 16 additional client devices can connect to the central coordinator 102). In other embodiments (e.g., if there is heavy traffic in the communication network 100), the registration unit 106 may restrict the number of client devices that can connect to the communication network 100. For example, even though the communication superframe comprises 18 communication time slots, the registration unit 106 may indicate, in the beacon message 202, that there are two client devices in the communication network and only 6 available communication time slots. In some embodiments, the registration unit 106 may dynamically change the number of client devices that are permitted to join the communication network 100, the size of the communication time slots, and/or the number of communication time slots per communication superframe. Referring to the above example where the registration unit 106 advertises 6 available communication time slots, if network conditions improve, the registration unit 106 may advertise that 16 communication time slots are available. The flow continues at block 304.

At block 304, it is determined whether a request message to join the communication network was received from a client device. In some embodiments, the request message can be a WLAN association request message that comprises communication capabilities (e.g., supported communication protocols, data rates, etc.) and current configuration of the requesting client device (e.g., the client device 112). In addition, the client device 112 may also select a communication time slot (from the list of available communication time slots received in the beacon) and can request (in the request message) that the selected communication time slot be assigned to the client device 112. If the registration unit 106 determines that a request message to join the communication network 100 was received from one or more client devices, the flow continues at block 306. Otherwise, the flow loops back to block 304 where the registration unit 106 continues to determine whether a request message to join the communication network was received from one or more client devices. In some embodiments, a background process of the central coordinator 102 can continuously check for request messages to join the communication network while other processing units of the central coordinator 102 transmit beacon messages, transmit messages to other connected client devices, receive and process messages from other client devices, etc.

At block 306, it is determined whether the client device should be permitted to join the communication network. The flow 300 moves from block 304 to bock 306 if the registration unit 106 determines that the client device 112 requested permission to join the communication network 100. For example, to determine whether the client device 112 should be permitted to join the communication network 100, the registration unit 106 can determine whether the client device 112 is compatible with the central coordinator 102. The registration unit 106 can analyze the client device's communication capabilities (received in the request message at block 304) and the central coordinator's communication capabilities and can accordingly determine whether the client device 112 should be permitted to join the communication network 100. For example, the client device 112 may not be permitted to join the communication network 100 if the client device 112 does not support high-speed data communication (e.g., IEEE 802.11n protocols). If the registration unit 106 determines that the client device 112 should be permitted to join the communication network 100, the flow continues at block 310. Otherwise, the flow continues at block 308.

At block 308, if the client device should not be permitted to join the communication network, a message preventing the client device from joining the communication network is transmitted to the client device. For example, the registration unit 106 can transmit (via the transceiver unit 108) a WLAN association response message to the client device including a “denied” status indicating that the client device 112 is not permitted to join the communication network 102. From block 308, the flow ends.

At block 310, if the client device should be permitted to join the network, a communication time slot that should be assigned to the client device is determined. In some embodiments, as discussed above in block 304, the client device 112 may request a specific communication time slot based on knowledge of available communication time slots (e.g., received in the beacon message 202 from the central coordinator 102). If the communication time slot requested by the client device 112 is available, the registration unit 106 may assign the requested communication time slot to the client device 112. If the communication time slot requested by the client device 112 is not available (or if the client device 112 did not request a specific communication time slot), the registration unit 106 can select one of the available communication time slots and assign this selected communication time slot to the client device 112. The registration unit 106 may also store an indication of the communication time slot 216 assigned to the client device and a client device identifier in the time slot database 120. The flow continues at block 312.

At block 312, an acknowledgement message is transmitted to the client device including the communication time slot assigned to the client device. For example, the registration unit 106 can transmit (via the transceiver unit 108) a WLAN association response message to the client device 112 including an “accepted” status indicating that the client device 112 is permitted to join the communication network 100. The acknowledgment message may also include an indication of the communication time slot assigned to the client device 112. In some embodiments, the acknowledgement message can include an identifier of the communication time slot 216 (e.g., the second communication time slot) assigned to the client device 112. In another embodiment, the acknowledgement message can identify the communication time slot 216 assigned to the client device 112 in terms of an offset from a reference time instant (e.g., a time offset from the start of the beacon message 202, a time offset from the end of the beacon message 202, a time offset from the start of the communication superframe, and so on.) The flow continues at block 314.

At block 314, one or more security handshake messages are exchanged with the client device to establish a session key for subsequent communication with the client device. The central coordinator 102 (e.g., the registration unit 106 or another suitable security unit) and the client device 112 can employ any suitable security protocol to exchange handshake messages (e.g., using out-of-band communications) and to establish the session key for subsequent secure communication. After the session key is established, the registration process between the client device 112 and the central coordinator 102 may be deemed to be completed and the client device 112 can switch to a data communication mode. In the data communication mode, the client device 112 and the central coordinator 102 can exchange communications during the communication time slot 216 assigned to the client device 112. From block 314, the flow ends.

The registration process described above enables the central coordinator 102 to assign communication time slots (e.g., predefined time intervals) to each of the client devices in the communication network 100 so that each of the client devices may transmit/receive packets only during their assigned communication time slots. This can minimize the possibility of contention and interference between client devices within the communication network 100. However, communications in external networks may still interfere with the communication network 100. To minimize interference in the communication network 100 from external networks, the central coordinator 102 (e.g., the channel switch unit 110) can execute channel switching operations described below in FIGS. 4 and 5.

FIG. 4 and FIG. 5 depict a flow diagram 400 illustrating example operations of a central coordinator executing communication channel switching operations. The flow begins at block 402 in FIG. 4.

At block 402, a central coordinator determines performance measurements associated with a current communication channel of a communication network. In some embodiments, the channel switch unit 110 (of the central coordinator 102) may continuously or periodically monitor one or more performance measurements of the current communication channel. For example, the channel switch unit 110 can determine a communication channel latency, a packet error rate (PER), a signal-to-noise ratio (SNR), and/or other suitable performance measurements. The flow continues at block 404.

At block 404, performance measurements associated with an alternate communication channel is determined based, at least in part, on communications detected on the alternate communication channel. In some embodiments, the channel switch unit 110 may determine the performance measurements (e.g., communication latency, PER, SNR, etc.) associated with the alternate communication channel if the channel switch unit 110 detects traffic on external communication networks. In some embodiments, the channel switch unit 110 may determine the performance measurements associated with the alternate communication channel if the channel switch unit 110 detects that the traffic on the external communication networks exceeds a predetermined threshold amount of traffic. In some embodiments, the channel switch unit 110 may continuously or periodically determine the performance measurements associated with the alternate communication channel. In other embodiments, the channel switch unit 110 may determine the performance measurements associated with the alternate communication channel if the performance of the current communication channel degrades (e.g., if the performance measurements of the current communication channel are not in accordance with corresponding performance measurement thresholds). In some embodiments, the central coordinator 102 may also include a secondary receiver unit (not shown in FIG. 1) that detects communications on the alternate communication channel to enable the channel switch unit 110 to calculate the performance measurements associated with the alternate communication channel. In other embodiments, the central coordinator 102 may not include a secondary receiver unit. Instead, a receiver unit of the transceiver unit 108 may detect communications on the alternate communication channel. The flow continues at block 406.

At block 406, it is determined whether the performance measurements of the alternate communication channel are better than the performance measurements of a current communication channel. For example, the channel switch unit 110 may determine whether the latency of the alternate communication channel is less than the latency of the current communication channel. As another example, the channel switch unit 110 may determine whether a combination of the latency and the PER of the alternate communication channel is less than a combination of the latency and the PER of the current communication channel. In some embodiments, the channel switch unit 110 may determine whether the absolute value of the performance measurements of the alternate communication channel are better than corresponding absolute value of the performance measurements of a current communication channel. For example, the channel switch unit 110 may determine whether the PER of the alternate communication channel is less than the PER of the current communication channel. In other embodiments, the channel switch unit 110 may determine whether the performance measurements of the alternate communication channel are better than corresponding performance measurements of the current communication channel by a predefined percentage value. For example, the channel switch unit 110 may determine whether the PER of the alternate communication channel is less than the PER of the current communication channel by at least 5% of the PER of the current communication channel. If the channel switch unit 110 determines that the performance measurements of the alternate communication channel are better than performance measurements of the current communication channel, the flow continues at block 410. Otherwise, the flow continues at block 408. It should be noted that the channel switch unit 110 can determine the performance measurements associated with any suitable number of alternate communication channels. The channel switch unit 110 can compare the performance measurements of the current communication channel against the performance measurements of the all the alternate communication channels and can determine whether to switch to any of the alternate communication channels.

At block 408, the central coordinator determines not to switch to the alternate communication channel. The flow 400 moves from block 406 to block 408 if the channel switch unit 110 determines that the performance measurements of the alternate communication channel are not better than the performance measurements of the current communication channel. The channel switch unit 110 may also determine not to switch to the alternate communication channel if the performance measurements of the alternate communication channel are only marginally better than (e.g., less than a predetermined percentage of) the performance measurements of the current communication channel. From block 408, the flow ends.

At block 410, a channel switch message is transmitted to a multicast destination address corresponding to all client devices associated with the central coordinator indicating a pending switch to the alternate communication channel. The flow 400 moves from block 406 to block 410 if the channel switch unit 110 determines that the performance measurements of the alternate communication channel are better than performance measurements of the current communication channel. In some embodiments, the channel switch message transmitted to the multicast destination address (also referred to herein as a “multicast channel switch message”) can comprise an identifier of the alternate communication channel (e.g., a channel identifier, a frequency band of the alternate communication channel, etc.). The multicast channel switch message can also indicate a time instant (“channel switch time instant”) at which the client devices should switch to the alternate communication channel. In some embodiments, the channel switch time instant may be determined based on: 1) a maximum time interval for which the channel switch unit 110 waits to receive acknowledgements to the multicast channel switch message, 2) time to transmit the unicast channel switch messages, 3) maximum time interval for which the channel switch unit 110 waits to receive acknowledgements to the unicast channel switch message, 4) a maximum number of times the channel switch unit 110 retransmits the unicast channel switch message, and/or 5) other network considerations (e.g., network latency). In some embodiments, the channel switch unit 110 may indicate an exact time instant (e.g., 13:05:07:000) at which the client devices should switch to the alternate communication channel. In another embodiment, the channel switch unit 110 may indicate a time interval (e.g., 5 ms after current time instant) after which the client devices should switch to the alternate communication channel. In another embodiment, the channel switch unit 110 may indicate that the client devices should switch to the alternate communication channel immediately after the next beacon message. In another embodiment, the channel switch unit 110 may indicate that the client devices should switch to the alternate communication channel Xms after the next beacon message is transmitted. The flow continues at block 412 in FIG. 5.

At block 412 in FIG. 5, it is determined whether acknowledgement messages were received from all the client devices addressed in the multicast channel switch message. In some embodiments, the channel switch unit 110 may transmit the multicast channel switch message before the start of the communication superframe 208. In another embodiment, the channel switch unit 110 may transmit the multicast channel switch message during an unassigned communication time slot of the communication superframe 208. In another embodiment, the channel switch unit 110 may transmit the multicast channel switch message during a communication time slot assigned for multicast/broadcast transmissions of the central coordinator 102. In another embodiment, the channel switch unit 110 may transmit the multicast channel switch message during a communication time slot (assigned to any client device) that is currently not being used (e.g., if the central coordinator 102 detects that it has no data for the client device and that the client device has no data to transmit). The channel switch unit 110 may monitor the communication time slots within the communication superframe 208 to receive an acknowledgement message from each of the client devices in the communication network 100. If the channel switch unit 110 determines that the acknowledgement messages were received from all the client devices addressed in the multicast channel switch message, the flow continues at block 418. Otherwise, if the channel switch unit 110 determines that the acknowledgement messages were not received from one or more client devices, the flow continues at block 414.

At block 414, the central coordinator defers switching to the alternate communication channel and transmits a unicast channel switch message to client devices that did not transmit the acknowledgement message. The flow 400 moves from block 412 to block 414 if the channel switch unit 110 determines that acknowledgement messages were not received from one or more client devices. The channel switch unit 110 may determine not switch to the alternate communication channel until all the client devices in the communication network 100 have acknowledged the proposed switch to the alternate communication channel. In some embodiments, if the channel switch unit 110 does not receive an acknowledgement message from all the client devices (e.g., at least Xms before the channel switch time instant), the channel switch unit 110 can transmit another multicast message to the client devices indicating that the client devices should switch to the alternate communication channel at a new channel switch time instant. In other embodiments, the channel switch unit 110 may transmit (e.g., via the transceiver unit 108) a “defer channel switch” message to a multicast destination address (or a second multicast channel switch message) to cause the client devices to defer switching to the alternate communication channel. In some embodiments, the defer channel switch message can indicate the new channel switch time instant at which the client devices should switch to the alternate communication channel. Accordingly, the channel switch unit 110 can ensure that none of the client devices is dropped from the communication network 100 and that all the client devices switch to the alternate communication channel at the same time. For each of the one or more client devices that did not transmit the acknowledgement message, the channel switch unit 110 can identify a communication time slot assigned to the client device. The channel switch unit 110 can transmit (e.g., via the transceiver unit 108) the unicast channel switch message to the client device during the communication time slot associated with the client device. The unicast channel switch message can comprise the new channel switch time instant at which the client devices should switch to the alternate communication channel. It is noted that the second multicast channel switch message or the defer channel switch message may be transmitted before or after the unicast channel switch messages are transmitted. It is noted that in some embodiments, the non-responsive client device may receive the unicast channel switch message in addition to the defer channel switch message (or the second multicast channel switch message). In other embodiments, the non-responsive client device may only receive the unicast channel switch message and may not receive the defer channel switch message (or the second multicast channel switch message). The flow continues at block 416.

At block 416, it is determined whether acknowledgement messages were received from the client devices in response to the unicast channel switch message. If the channel switch unit 110 determines that acknowledgement messages were received from all the client devices (to which the unicast channel switch messages were transmitted), the flow continues at block 418. Otherwise, the flow loops back to block 414 where the channel switch unit 110 defers switching to the alternate communication channel and transmits a unicast channel switch message to client devices that did not transmit the acknowledgement message.

At block 418, the central coordinator and the client devices in the communication network switch to the alternate communication channel. The flow 400 moves from block 412 (and from block 416) to block 418 after the channel switch unit 110 determines that acknowledgement messages were received from all the client devices associated with the central coordinator 102. From block 418, the flow ends.

FIG. 6 is a flow diagram 600 illustrating example operations of a client device connecting to and communicating with a central coordinator of a communication network. The flow 600 begins at block 602.

At block 602, a client device detects a beacon message advertising support of a low-latency, high bandwidth integration process from a central coordinator of a communication network. For example, the connection and configuration unit 116 can receive the beacon message 202 from the central coordinator 102 of the communication network 100. As discussed above with reference to FIG. 3, the beacon message 202 can comprise communication capabilities and configuration of the central coordinator 102, a list of available communication time slots, etc. The flow continues at block 604.

At block 604, a request message including a preferred communication time slot is transmitted from the client device to the central coordinator. For example, the connection and configuration unit 116 can transmit a request message (e.g., a WLAN association request message) requesting permission to join the communication network 100. As described above in FIG. 3, in some implementations, the connection and configuration unit 116 can receive a beacon message from the central coordinator 102 that identifies the available communication time slots. In some implementations, the connection and configuration unit 116 may attempt to reserve one of the available communication time slots for the client device 112 by transmitting an indication of one of the available communication time slots in the request message. The flow continues at block 606.

At block 606, it is determined whether the client device is permitted to join the communication network. In some embodiments, the connection and configuration unit 116 may receive a WLAN association response message indicating whether the client device 112 is permitted to join the communication network 100. In some embodiments, if the client device 112 is permitted to join the communication network 100, then the connection and configuration unit 116 may also receive a notification of a communication time slot assigned to the client device 112. The communication time slot assigned to the client device 112 may be the same as or different from the preferred communication time slot requested by the client device 112 at block 604. Once the client device 112 receives its assigned communication time slot, the connection and configuration unit 116 can determine a time offset associated with the communication time slot. If the client device 112 is permitted to join the communication network 100, the flow continues at block 608. Otherwise, if the client device 112 is not permitted to join the communication network 100, the flow ends.

At block 608, one or more security handshake messages are exchanged with the central coordinator to establish a session key for subsequent communication with the central coordinator. As described above with reference to block 314 of FIG. 3, the central coordinator 102 and the client device 112 can employ any suitable security protocol to establish the session key for subsequent secure communication. After the session key is established, the registration process between the client device 112 and the central coordinator 102 may be deemed to be complete and the client device 112 can switch to a data communication mode. The flow continues at block 610.

At block 610, the client device 112 determines to transmit one or more uplink packets to the central coordinator 102. As described above with reference to FIG. 1, in some embodiments, the uplink packets scheduled to be transmitted by the client device 112 can comprise low-latency control commands, high bandwidth audio data, or a combination of control commands and audio data. In other embodiments, the client device 112 can transmit other suitable data to the central coordinator 102 (e.g., video, text, etc.). The flow continues at block 612.

At block 612, a time instant at which to begin transmission of the one or more uplink packets is determined based, at least in part, on the communication time slot assigned to the client device. As described above with reference to FIG. 1, the client device 112 can calculate a time offset with reference to a start of the communication superframe, with reference to the start/end of a beacon message, etc. If the time offset is calculated with reference to the start of the communication superframe, then the time instant at which the superframe begins may be assumed to be a well-known value by the client device 112 or may be communicated to the client device 112 in the beacon message. In some embodiments, the client device 112 can receive information about the start of the superframe relative to the start of the beacon interval, the duration of the superframe, the duration of each communication time slot, the number of communication superframes per beacon interval, the length of the communication superframe, etc. during the registration process (described above in FIG. 3). In another embodiment, the client device 112 can receive this information in other suitable messages (e.g., in the response message granting permission to join the communication network 100, in an initialization message, etc.). The client device 112 can store this information for the duration of the communication session and can calculate the time instant at which to begin transmission. In some embodiments, the communication time slot assigned to the client device 112 may be used for transmitting different types of data (e.g., whether control commands, audio, video, etc.) depending on the latency requirements and priority of the different types of data. For example, if the client device 112 is scheduled to transmit low latency control commands and higher latency audio data, the client device 112 may first transmit the low latency control commands and then transmit the higher latency audio data. In one embodiment of this example, the client device 112 can transmit the control commands during its assigned communication time slot in a first communication superframe and can transmit the audio data in its assigned communication time slot in a second communication superframe. In another embodiment of this example, the client device 112 can transmit all the control commands and at least a portion of the audio data during its assigned communication time slot in the first communication superframe and can transmit the remaining audio data in its assigned communication time slot in the second communication superframe. In some embodiments, the communication time slot assigned to the client device 112 may be further sub-divided into sub-slots for transmitting high latency control commands, for transmitting high bandwidth audio data, for receiving data (e.g., control commands, audio data, video data, etc.) from the central coordinator 102, and for retransmitting packets if necessary. In some embodiments, the client device 112 and the central coordinator 102 can each maintain a local timing synchronization function (TSF) timer as part of the WLAN (e.g., 802.11) communication protocol. The client device 112 can determine the timing offset associated with its assigned communication time slot and can also determine when to transmit the packets to the central coordinator 102 based on the TSF and the assigned communication time slot. For example, the client device 112 can determine that the timing offset is 1000 microseconds and that it should transmit packets (e.g., that its communication time slot begins) every 8000 microseconds. Accordingly, the client device 112 can transmit packets to the central coordinator 102 at t=1000 microseconds, t=9000 microseconds, t=17000 microseconds, and so on. The flow continues at block 614.

At block 614, it is determined whether to transmit the uplink packets to the central coordinator. For example, the client device 112 can determine whether the communication time slot 216 assigned to the client device 112 has begun (e.g., whether the time instant determined at block 612 has elapsed). If it is determined that the communication time slot assigned to the client device 112 has begun, the flow continues at block 616. Otherwise, the flow loops back to block 614 where the client device 112 waits until the communication time slot 216 assigned to the client device 112 begins.

At block 616, the one or more uplink packets are transmitted to the central coordinator at the beginning of the communication time slot assigned to the client device. From block 616, the flow ends.

It is noted that, the central coordinator 102 may determine to transmit downlink data (e.g., control commands, audio data, video data, etc.) to a destination client device 112. The central coordinator 102 can access the time slot database 120 and can determine which communication time slot was assigned to the destination client device 112. The central coordinator 102 can then transmit the downlink data to the destination client device 112 during the appropriate communication time slot assigned to the destination client device 112. In some embodiments, if the central coordinator 102 has multiple types of data to transmit to the destination client device 112, the central coordinator 102 may determine which subset of the data should be transmitted to the destination client device 112 based on latency and delivery requirements associated with the different types of data. In some examples, the latency associated with control command data may be 4 ms, the latency associated with audio data may be 20 ms, and the latency associated with video data may be 32 ms. If the central coordinator 102 has video data and control command data to transmit to the destination client device 112, the central coordinator 102 can buffer the video data and can transmit the control command data in the communication time slot of the first communication superframe. During the client device's communication time slot of the second communication superframe, the central coordinator 102 can aggregate the buffered video data with new video data and transmit a packet comprising the aggregated video data to the destination client device 112. Alternately, during the client device's communication time slot of the first communication superframe, the central coordinator 102 can aggregate the control command data and at least a portion of the video data and transmit a packet comprising the data to the destination client device 112. During the client device's communication time slot of the second communication superframe, the central coordinator 102 can transmit a packet comprising the remaining video data to the destination client device 112.

To transmit to multiple client devices, the central coordinator 102 can identify the communication time slot associated with each of the multiple client devices. The central coordinator 102 can then transmit data to the multiple client devices during their respective communication time slots. For example, suppose that the central coordinator 102 determines to transmit data to a first client device, a second client device, and a third client device in the communication network 100. The central coordinator 102 can access the time slot database 120 and identify which communication time slots of the communication superframe were assigned to each of the client devices. With reference to FIG. 2, the central coordinator 102 may determine that the communication time slots 214, 216, and 218 were assigned to the first, second, and third clients respectively. Accordingly, depending on the type of data scheduled to be transmitted and the latency requirements associated with the data scheduled to be transmitted, the central coordinator 102 can transmit data to the first client device during the communication time slot 214, can transmit data to the second client device during the communication time slot 216, and can transmit data to the third client device during the communication time slot 218. Thus, depending on the data available for each of the multiple client devices, the central coordinator 102 can transmit different types of data to different client devices. For example, during the same communication superframe, the central coordinator 102 can transmit low latency data to a first client device during the first client device's communication time slot, transmit higher latency audio data to a second client device during the second client device's communication time slot, and so on.

It should be understood that FIGS. 1-6 and operations described herein are examples meant to aid in understanding embodiments and should not be used to limit embodiments or limit scope of the claims. Embodiments may perform additional operations, fewer operations, operations in a different order, operations in parallel, and some operations differently. Although not depicted above in the Figures, after the client device 112 transmits the uplink packet (including the control commands and/or the audio data) to the central coordinator 102, the central coordinator 102 can receive the packet and provide the packet to subsequent processing units. In some embodiments, the central coordinator 102 may simply forward the packets to the subsequent processing units without analyzing/decoding the packets. In another embodiment, the central coordinator 102 may decode the packet and provide the payload (including an identifier of the client device 112 that transmitted the packet) to the subsequent processing units. In another embodiment, the central coordinator 102 may decode the packet, analyze the packet to determine the type of data that is transmitted (e.g., whether control commands, audio data, etc.) and provide the payload to the appropriate processing units depending on the type of the data.

It is also noted that in some embodiments, the communication range between the central coordinator 102 and the client devices may be very short (e.g., less than 20 feet). Accordingly, high data communication rates (e.g., using IEEE 802.11n communication protocols) may be used to transmit packets between the central coordinator 102 and each of the client devices and to minimize the time for which a packet is on the communication medium. Minimizing the amount of time utilized to transmit a packet can enable a larger number of packets to be transmitted within a communication superframe. In other words, because the communication superframe effectively enables integration of data streams associated with multiple client devices, minimizing the amount of time utilized to transmit a given packet can enable the central coordinator 102 to support a larger number of client devices and can enable a larger number of client devices to transmit their data streams within a communication superframe of a predetermined size.

As will be appreciated by one skilled in the art, aspects of the present inventive subject matter may be embodied as a system, method, or computer program product. Accordingly, aspects of the present inventive subject matter may take the form of an entirely hardware embodiment, a software embodiment (including firmware, resident software, micro-code, etc.) or an embodiment combining software and hardware aspects that may all generally be referred to herein as a “circuit,” “module” or “system.” Furthermore, aspects of the present inventive subject matter may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present inventive subject matter may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present inventive subject matter are described with reference to flowchart illustrations and/or block diagrams of methods, apparatus (systems) and computer program products according to embodiments of the inventive subject matter. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

FIG. 7 is a block diagram of one embodiment of an electronic device 700 including a mechanism for minimizing interference in a communication network. In some embodiments, the electronic device 700 may be a gaming console that coordinates communications with different gaming controllers. In some embodiments, the electronic device 700 can be a laptop computer, a tablet computer, a netbook, a mobile phone, a smart appliance, a desktop computer, a network bridge device, or other suitable electronic device comprising communication capabilities. The electronic device 700 includes a processor unit 702 (possibly including multiple processors, multiple cores, multiple nodes, and/or implementing multi-threading, etc.). The electronic device 700 includes a memory unit 706. The memory unit 706 may be system memory (e.g., one or more of cache, SRAM, DRAM, zero capacitor RAM, Twin Transistor RAM, eDRAM, EDO RAM, DDR RAM, EEPROM, NRAM, RRAM, SONOS, PRAM, etc.) or any one or more of the above already described possible realizations of machine-readable storage media. The electronic device 700 also includes a bus 710 (e.g., PCI, ISA, PCI-Express, HyperTransport®, InfiniBand®, NuBus, AHB, AXI, etc.). In some embodiments, the electronic device 700 may comprise a network interface 704 that include at least one of a wireless network interface (e.g., a WLAN interface, a Bluetooth® interface, a WiMAX interface, a ZigBee® interface, a Wireless USB interface, etc.) and/or a wired network interface (e.g., a powerline communication interface, an Ethernet interface, etc.).

The electronic device 700 also includes a communication unit 708. The communication unit 708 comprises a registration unit 712 and a channel switch unit 714. The communication unit 708 can execute functionality for registering client devices, assigning communication time slots to each of the registered client devices, communicating with the client devices during their respective assigned communication time slots, and switching (if needed) to an alternate communication channel with better performance, as described above with reference to FIGS. 1-6.

Any one of these functionalities may be partially (or entirely) implemented in hardware and/or on the processor unit 702. For example, the functionality may be implemented with an application specific integrated circuit, in logic implemented in the processor unit 702, in a co-processor on a peripheral device or card, etc. Further, realizations may include fewer or additional components not illustrated in FIG. 7 (e.g., video cards, audio cards, additional network interfaces, peripheral devices, etc.). For example, the communication unit 708 may comprise one or more additional processors that are distinct from the processor unit 702 coupled with the bus 710. The processor unit 702, the memory unit 706, and the network interfaces 704 are coupled to the bus 710. Although illustrated as being coupled to the bus 710, the memory unit 706 may be coupled to the processor unit 702.

While the embodiments are described with reference to various implementations and exploitations, it will be understood that these embodiments are illustrative and that the scope of the inventive subject matter is not limited to them. In general, a mechanism for minimizing interference in a communication network as described herein may be implemented with facilities consistent with any hardware system or hardware systems. Many variations, modifications, additions, and improvements are possible.

Plural instances may be provided for components, operations, or structures described herein as a single instance. Finally, boundaries between various components, operations, and data stores are somewhat arbitrary, and particular operations are illustrated in the context of specific illustrative configurations. Other allocations of functionality are envisioned and may fall within the scope of the inventive subject matter. In general, structures and functionality presented as separate components in the exemplary configurations may be implemented as a combined structure or component. Similarly, structures and functionality presented as a single component may be implemented as separate components. These and other variations, modifications, additions, and improvements may fall within the scope of the inventive subject matter.

What is claimed is:

1. A method comprising:
determining, at a central coordinator of a communication network, to switch from a current communication channel to an alternate communication channel;
transmitting a first channel switch message to a plurality of client devices associated with the central coordinator in the communication network;
determining whether an acknowledgement for the first channel switch message is received from each of the plurality of client devices;
switching to the alternate communication channel in response to determining that the acknowledgement for the first channel switch message is received from each of the plurality of client devices;
determining not to switch to the alternate communication channel in response to determining that the acknowledgement for the first channel switch message is not received from a first client device of the plurality of client devices; and
transmitting a second channel switch message to the first client device in response to determining that the acknowledgement for the first channel switch message is not received from the first client device.

2. The method of claim 1, wherein
the first channel switch message comprises an indication of a first channel switch time instant at which the central coordinator and the plurality of client devices should switch to the alternate communication channel.

3. The method of claim 1, wherein
the first channel switch message is a multicast channel switch message or a broadcast channel switch message that is transmitted to the plurality of client devices associated with the central coordinator, and
the second channel switch message is a unicast channel switch message that is transmitted to the first client device.

4. The method of claim 3, wherein said switching to the alternate communication channel in response to determining that the acknowledgement for the first channel switch message is received from each of the plurality of client devices comprises:
switching to the alternate communication channel at the first channel switch time instant indicated in the first channel switch message.

5. The method of claim 3, wherein
said determining not to switch to the alternate communication channel comprises:
transmitting, to the plurality of client devices, a third channel switch message indicating a second channel switch time instant to cause the remainder of the plurality of client devices to defer switching to the alternate communication channel, wherein the second channel switch time instant is later in time than the first channel switch time instant; and
said transmitting the second channel switch message to the first client device comprises:
transmitting, to the first client device, the second channel switch message indicating the second channel switch time instant.

6. The method of claim 5, wherein said transmitting the second channel switch message to the first client device further comprises:
determining whether an acknowledgement for the second channel switch message is received from the first client device;
switching to the alternate communication channel at the second channel switch time instant indicated in the second channel switch message transmitted to the first client device and the third channel switch message transmitted to the plurality of client devices, in response to determining that the acknowledgement for the second channel switch message is received from the first client device; and
preventing remainder of the plurality of client devices from switching to the alternate communication channel, in response to determining that the acknowledgement for the second channel switch message is not received from the first client device.

7. The method of claim 1, further comprising:
determining a performance measurement associated with the current communication channel of the communication network;
determining a performance measurement associated with the alternate communication channel of the communication network;
comparing the performance measurement associated with the current communication channel against the performance measurement associated with the alternate communication channel;
determining to switch from the current communication channel to the alternate communication channel, in response to determining that the performance measurement associated with the alternate communication channel surpasses the performance measurement associated with the current communication channel; and
determining not to switch from the current communication channel to the alternate communication channel, in response to determining that the performance measurement associated with the alternate communication channel does not surpass the performance measurement associated with the current communication channel.

8. The method of claim 7, wherein said determining the performance measurement associated with the alternate communication channel of the communication network is in response to determining that the performance measurement associated with the current communication channel is not in accordance with a performance measurement threshold.

9. The method of claim 1, comprising:
determining a performance measurement associated with the current communication channel of the communication network;
determining a performance measurement associated with a plurality of alternate communication channels of the communication network;
comparing the performance measurement associated with the current communication channel against the performance measurement associated with each of the plurality of alternate communication channels;
determining to switch from the current communication channel to a first alternate communication channel, in response to determining that the performance measurement associated with the first alternate communication channel of the plurality of alternate communication channels surpasses the performance measurement associated with the current communication channel; and
determining not to switch from the current communication channel to any of the plurality of alternate communication channels, in response to determining that the performance measurement associated with each of the plurality of alternate communication channels do not surpass the corresponding performance measurement associated with the current communication channel.

10. The method of claim 1, further comprising:
registering the plurality of client devices at the central coordinator by assigning a different one of a plurality of communication time slots of a periodic service period to each of the plurality of client devices;
determining to transmit one or more downlink data packets to at least the first client device associated with the central coordinator;
determining that a first communication time slot of the plurality of communication time slots of the periodic service period is assigned for communication with the first client device; and
transmitting the one or more downlink data packets to the first client device during the first communication time slot assigned to the first client device.

11. The method of claim 10, wherein said transmitting the second channel switch message to the first client device comprises:
transmitting the second channel switch message to the first client device during the first communication time slot assigned to the first client device.

12. The method of claim 10, wherein
said determining that the first communication time slot is assigned for communication with the first client device comprises determining a time instant at which to transmit the one or more downlink data packets to the first client device based, at least in part, on the first communication time slot assigned to the first client device; and
said transmitting the one or more downlink data packets to the first client device comprises transmitting the one or more downlink data packets to the first client device at the time instant.

13. The method of claim 10, wherein a beacon interval associated with the central coordinator comprises one or more periodic service periods such that,
a start time instant of a first of the one or more periodic service periods coincides with a start time instant of the beacon interval, or
the start time instant of the first of the one or more periodic service periods begins a predetermined time interval after the start time instant of the beacon interval.

14. The method of claim 10, wherein said registering the plurality of client devices at the central coordinator of the communication network by assigning a different one of the plurality of communication time slots of the periodic service period to each of the plurality of client devices comprises:
transmitting a beacon message from the central coordinator in the communication network, wherein the beacon message comprises at least a subset of the plurality of communication time slots available to be assigned;
receiving, from the first client device, a request message comprising a request to join the communication network, one or more communication capabilities of the first client device, and an indication of one of the subset of the plurality of communication time slots;
determining to assign the first communication time slot to the first client device for subsequent communication with the first client device, wherein the first communication time slot is one of the subset of the plurality of communication time slots available to be assigned; and
notifying the first client device of the first communication time slot assigned to the first client device.

15. The method of claim 14, wherein the beacon message comprises a number of the plurality of client devices connected to the central coordinator in the communication network, the subset of the plurality of communication time slots available to be assigned, and communication capabilities of the central coordinator.

16. The method of claim 14, further comprising:
determining whether to permit the first client device to join the communication network based, at least in part, on the one or more communication capabilities of the first client device received in the request message;
transmitting an acknowledgement message to the first client device indicating permission to join the communication network and an indication of the first communication time slot assigned to the first client device, in response to determining to permit the first client device to join the communication network; and
transmitting an acknowledgement message to the first client device denying permission to join the communication network, in response to determining not to permit the first client device to join the communication network.

17. The method of claim 10, wherein the one or more downlink data packets comprise at least one of low latency control commands, high bandwidth audio data, and high bandwidth video data.

18. The method of claim 10, further comprising:
receiving, at the central coordinator, one or more uplink data packets from the first client device during the first communication time slot assigned to the first client device.

19. The method of claim 18, wherein the first communication time slot comprises one or more retransmission sub-intervals for re-transmitting the one or more uplink data packets and the one or more downlink data packets.

20. The method of claim 18, wherein the one or more uplink data packets comprise at least one of low latency control data and high bandwidth audio data.

21. The method of claim 1, wherein
the communication network is a gaming network,
the central coordinator is a gaming console, and
the first client device is a gaming controller for providing user input to the central coordinator.

22. A coordinating network device comprising:
a processor;
a communication unit coupled with the processor, the communication unit operable to:
determine to switch from a current communication channel to an alternate communication channel of a communication network;
transmit a first channel switch message to a plurality of client devices associated with the coordinating network device in the communication network;
determine whether an acknowledgement for the first channel switch message is received from each of the plurality of client devices;
switch to the alternate communication channel in response to determining that the acknowledgement for the first channel switch message is received from each of the plurality of client devices;
determine not to switch to the alternate communication channel in response to determining that the acknowledgement for the first channel switch message is not received from a first client device of the plurality of client devices; and
transmit a second channel switch message to the first client device in response to determining that the acknowledgement for the first channel switch message is not received from the first client device.

23. The coordinating network device of claim 22, wherein the first channel switch message comprises an indication of a first channel switch time instant at which the coordinating network device and the plurality of client devices should switch to the alternate communication channel.

24. The coordinating network device of claim 22, wherein
the first channel switch message is a multicast channel switch message or a broadcast channel switch message that is transmitted to the plurality of client devices associated with the coordinating network device, and
the second channel switch message is a unicast channel switch message that is transmitted to the first client device

25. The coordinating network device of claim 24, wherein
the communication unit operable to determine not to switch to the alternate communication channel comprises the communication unit operable to:
transmit, to the plurality of client devices, a third channel switch message indicating a second channel switch time instant to cause the remainder of the plurality of client devices to defer switching to the alternate communication channel, wherein the second channel switch time instant is later in time than the first channel switch time instant; and
the communication unit operable to transmit the second channel switch message to the first client device comprises the communication unit operable to:
transmit, to the first client device, the second channel switch message indicating the second channel switch time instant.

26. The coordinating network device of claim 24, wherein the communication unit operable to transmit the second channel switch message to the first client device further comprises the communication unit operable to:
determine whether an acknowledgement for the second channel switch message is received from the first client device;
switch to the alternate communication channel at the second channel switch time instant indicated in the second channel switch message transmitted to the first client device and the third channel switch message transmitted to the plurality of client devices, in response to determining that the acknowledgement for the second channel switch message is received from the first client device; and
prevent remainder of the plurality of client devices from switching to the alternate communication channel, in response to determining that the acknowledgement for the second channel switch message is not received from the first client device.

27. The coordinating network device of claim 22, wherein the communication unit is operable to:
determine a performance measurement associated with the current communication channel of the communication network;
determine a performance measurement associated with a plurality of alternate communication channels of the communication network;
compare the performance measurement associated with the current communication channel against the performance measurement associated with each of the plurality of alternate communication channels;
determine to switch from the current communication channel to a first alternate communication channel, in response to determining that the performance measurement associated with the first alternate communication channel of the plurality of alternate communication channels surpasses the performance measurement associated with the current communication channel; and
determine not to switch from the current communication channel to any of the plurality of alternate communication channels, in response to determining that the performance measurement associated with each of the plurality of alternate communication channels do not surpass the corresponding performance measurement associated with the current communication channel.

28. The coordinating network device of claim 22, wherein the communication unit is further operable to:
register the plurality of client devices at the coordinating network device by assigning a different one of a plurality of communication time slots of a periodic service period to each of the plurality of client devices;
determine to transmit one or more downlink data packets to at least the first client device;
determine that a first communication time slot of the plurality of communication time slots of the periodic service period is assigned for communication with the first client device; and
transmit the one or more downlink data packets to the first client device during the first communication time slot assigned to the first client device.

29. The coordinating network device of claim 28, wherein the communication unit operable to transmit the second channel switch message to the first client device comprises the communication unit operable to:
transmit the second channel switch message to the first client device during the first communication time slot assigned to the first client device.

30. The coordinating network device of claim 28, wherein the communication unit operable to register the plurality of client devices at the coordinating network device comprises the communication unit operable to:
transmit a beacon message to the plurality of client devices in the communication network, wherein the beacon message comprises at least a subset of the plurality of communication time slots available to be assigned;
receive, from the first client device, a request message comprising a request to join the communication network, one or more communication capabilities of the first client device, and an indication of one of the subset of the plurality of communication time slots;
determine to assign the first communication time slot to the first client device for subsequent communication with the first client device, wherein the first communication time slot is one of the subset of the plurality of communication time slots available to be assigned; and
notify the first client device of the first communication time slot assigned to the first client device.

31. One or more machine-readable storage media having instructions stored therein, which when executed by one or more processors causes the one or more processors to perform operations that comprise:
determining, at a central coordinator of a communication network, to switch from a current communication channel to an alternate communication channel;
transmitting a first channel switch message to a plurality of client devices associated with the central coordinator in the communication network;
determining whether an acknowledgement for the first channel switch message is received from each of the plurality of client devices;
switching to the alternate communication channel in response to determining that the acknowledgement for the first channel switch message is received from each of the plurality of client devices;
determining not to switch to the alternate communication channel in response to determining that the acknowledgement for the first channel switch message is not received from a first client device of the plurality of client devices; and
transmitting a second channel switch message to the first client device in response to determining that the acknowledgement for the first channel switch message is not received from the first client device.

32. The machine-readable storage media of claim 31, wherein
the first channel switch message comprises an indication of a first channel switch time instant at which the central coordinator and the plurality of client devices should switch to the alternate communication channel.

33. The machine-readable storage media of claim 31, wherein,
the first channel switch message is a multicast channel switch message or a broadcast channel switch message that is transmitted to the plurality of client devices associated with the central coordinator, and
the second channel switch message is a unicast channel switch message that is transmitted to the first client device

34. The machine-readable storage media of claim 33, wherein
said operation of determining not to switch to the alternate communication channel comprises:
transmitting, to the plurality of client devices, a third channel switch message indicating a second channel switch time instant to cause the remainder of the plurality of client devices to defer switching to the alternate communication channel, wherein the second channel switch time instant is later in time than the first channel switch time instant; and
said operation of transmitting the second channel switch message to the first client device comprises:
transmitting, to the first client device, the second channel switch message indicating the second channel switch time instant.

35. The machine-readable storage media of claim 34, wherein said operation of transmitting the second channel switch message to the first client device further comprises:
determining whether an acknowledgement for the second channel switch message is received from the first client device;
switching to the alternate communication channel at the second channel switch time instant indicated in the second channel switch message transmitted to the first client device and the third channel switch message transmitted to the plurality of client devices, in response to determining that the acknowledgement for the second channel switch message is received from the first client device; and
preventing remainder of the plurality of client devices from switching to the alternate communication channel, in response to determining that the acknowledgement for the second channel switch message is not received from the first client device.

36. The machine-readable storage media of claim 31, wherein the operations further comprise:
registering the plurality of client devices at the central coordinator by assigning a different one of a plurality of communication time slots of a periodic service period to each of the plurality of client devices;
determining to transmit one or more downlink data packets to at least the first client device associated with the central coordinator;
determining that a first communication time slot of the plurality of communication time slots of the periodic service period is assigned for communication with the first client device; and
transmitting the one or more downlink data packets to the first client device during the first communication time slot assigned to the first client device.

37. The machine-readable storage media of claim 36, wherein said operation of transmitting the second channel switch message to the first client device comprises:
transmitting the second channel switch message to the first client device during the first communication time slot assigned to the first client device.
